(19) United States
(12) Patent Application Publication
(10) Pub. No.: US 2025/0264208 A1
(43) Pub. Date: Aug. 21, 2025

(54) ARTIFICIAL SKYLIGHT DEVICE

(71) Applicant: SIGNIFY HOLDING B.V., EINDHOVEN (NL)

(72) Inventors: TIES VAN BOMMEL, HORST (NL); MARTINUS HERMANUS WILHELMUS MARIA VAN DELDEN, VENLO (NL)

(21) Appl. No.: 18/858,412

(22) PCT Filed: May 11, 2023
(86) PCT No.: PCT/EP2023/062581

§ 371 Date: Oct. 21, 2024

(30) Foreign Application Priority Data
May 17, 2022 (EP) 22173792.7

(51) Int. Cl. F21V 14/08; F21S 8/02; F21V 9/02; F21V 14/02; F21V 21/30; F21Y 115/10; H05B 47/155

(52) U.S. Cl. CPC F21V 14/08; F21S 8/026; F21V 9/02; F21V 14/02; F21V 21/30; H05B 47/155; F21Y 2115/10

(57) ABSTRACT

The present invention provides an artificial skylight (1) for providing artificial skylight light, the artificial skylight comprising a first light emitting surface (2) arranged to emit first light resembling the sky and a rim (3) circumscribing the first light emitting surface (2). At least a first portion of the rim (3) comprises a second light emitting surface (4) configured to emit a second light resembling the sun light. The first light emitting surface (4) is arranged at an angle 9 relative the second light emitting surface (5), wherein the angle 9 is from 92° to 100° and/or from 80° to 88°.

### TECHNICAL FIELD

The present invention is related to an artificial skylight for obtaining an artificial skylight/daylight or a natural window appearance.

### BACKGROUND

Artificial skylights provide emulation of at least certain aspects of an outdoor environment in an indoor environment. The demand for artificial skylights is increasing due to its beneficial properties for human wellbeing. Since people tend to spend a majority of their day indoors, which may remove them from natural daylight, there is an interest in creating artificial light, which may simulate the appearance and light of a natural window or skylight.

Thus, there is a constant need to provide improved artificial skylights having enhanced natural appearance.

EP2918901A1 discloses an artificial skylight lighting system.

US2018252374A1 discloses an artificial skylight fixture.

### SUMMARY

In view of the above discussion, an object of the present invention is to provide an improved artificial skylight as set out in the appended set of claims and may be described as follows:

An artificial skylight for providing artificial skylight light, said artificial skylight comprising: a first light emitting surface and a light exit window panel arranged downstream from said first light emitting surface, wherein the first light emitting surface is arranged to emit through a light exit window first light for resembling the sky, said light exit window extending in a plane P; a rim extending in a perpendicular direction from the light exit window and circumscribing and connecting said first light emitting surface and light exit window panel, wherein at least a portion of said rim comprises a second light emitting surface which is configured to emit through said light exit window a second light for resembling sunlight; wherein at least said light exit window panel is pivoted relative to the rim over an axis A extending through the rim along plane P, such that said light exit window panel is arranged at an angle θ with said second light emitting surface, wherein θ is in a range from 92° to 100° and/or from 80° to 88°. The artificial skylight for providing artificial skylight light according to the present invention thus comprises a first light emitting surface arranged to emit first light (for) resembling the sky. The first light emitting surface may be rectangular, square, circular, rhombic or oval. The first light emitting surface may have edge portions connecting the adjacent corners, and two diagonal portions connecting the opposite corners. The first light may have a dominant peak wavelength in the wavelength range from 430 nm to 490 nm. The first light emitting surface may comprise a plurality of first light emitting elements. The term “light emitting elements”, it intended to mean “comprising light emitting diodes (LEDs), a plurality of LEDs, and/or a plurality of LEDs arranged in a linear array”. Further, by the term “light emitting elements” it is meant a dense packing of LEDs. The dense packing of LEDs may be along the longitudinal axis of the artificial skylight.

The first light emitting surface may have length L and a width W. L may be in a range from 0.3 m to 2 m, preferably in a range from 0.4 m to 1.8 m, more preferably in a range from 0.5 m to 1.5 m, most preferably 0.6 m to 1.2 m. W may be in a range from 0.3 m to 2 m, preferably in a range from 0.4 m to 1.8 m, more preferably in a range from 0.5 m to 1.5 m, most preferably 0.6 m to 1.2 m. Preferably L is equal to W.

Each or any of the LEDs may comprise inorganic LED(s) and/or organic LED(s) (OLEDs). While reference is made herein to the light emitting elements as comprising LEDs, it is to be understood that each or any of the light emitting elements, in alternative or in addition to a LED, could comprise another or other types of light sources, such as another or other types of solid state light emitters. The light emitting elements may be arranged along (substantially) the entire surface of the light emitting surface of the artificial skylight.

The artificial skylight further comprises a rim circumscribing the first light emitting surface, wherein at least a first portion of the rim comprises a second light emitting surface configured to emit a second light (for) resembling the sun light. The first light emitting surface is arranged at an angle θ relative the second light emitting surface, wherein the angle θ is from 92° to 100° and/or from 80° to 88°, preferably in a range from 93° to 99° and/or from 81° to 87°, more preferably in a range from 94° to 98° and/or from 82° to 86°, most preferably in a range from 95° to 97° and/or from 83° to 85°. In other words, the angle between the first and the second light emitting surfaces is slightly deviating from 90°, thus providing an artificial skylight having a natural feel, resembling sunshine at an angle and/or a slightly tilted window for resembling breeze. Typically, the rim is formed as a cylinder, i.e. according to a surface generated by rotating a parallel line around a fixed line, and its second light emitting surface may comprise a plurality of second light emitting elements.

As is understood from the above, the present invention provides an artificial skylight having improved appearance, combining a naturally looking sky with an impression of an open window. Another way to describe the inventive artificial skylight seems.

An artificial skylight for providing artificial skylight light, said artificial skylight comprising: a first light emitting surface arranged to emit a first light for resembling the sky; a light exit window panel arranged downstream from said first light emitting surface, wherein said light exit window panel is configured to allow at least a portion of said first light to exit said artificial skylight; a rim circumscribing and connecting said first light emitting surface and said light exit window panel and extending substantially perpendicularly to said first light emitting surface, wherein at least a first portion of said rim comprises a second light emitting surface configured to emit a second light for resembling the sun light, said rim further circumscribing a light exit window, wherein said first light emitting surface is arranged opposite said light exit window, and wherein said light exit window panel is arranged at an angle θ relative said light exit window, wherein said angle θ is in a range from 92° to 100° and/or from 80° to 88°. Typically the rim is substantially perpendicular to the light exit window and the light exit window extends in a plane P.

The artificial skylight may have the feature that said rim and said first light emitting surface enclose a cavity, which cavity has the light exit window as an open end at a circumferential edge of the rim, said light exit window panel at least partly extends beyond the edge into the cavity. Yet, the light exit window panel may also be completely arranged within the cavity. The tilted orientation of the light exit window panel with respect to the light exit window, gives the impression of an open window, thus enhancing the realistic effect of the artificial skylight as a real skylight.

The first portion of said rim comprising the second light emitting surface may be in a range from 5% to 95%, preferably in a range from 15% to 85%, more preferably in a range from 20% to 80%, most preferably in a range from 30% to 70%, such as for example 65% of the total surface area of the rim.

The portion of the rim being free from the second light emitting surface may extend (substantially) perpendicularly to the first light emitting surface. The term “substantially perpendicularly” means perpendicularly or deviating from perpendicular by not more than 5°, preferably less than 2°, more preferably 1° or less, for example 0°. Alternatively, the angle between the portion of the rim being free from the second light emitting surface and the first light emitting surface may differ from 90°. In other words, the artificial skylight may have slanted appearance.

At least a second portion of the rim may comprise a third light emitting surface configured to emit a third light for resembling the shade, preferably wherein the second light emitting surface is greater than the third light emitting surface. The third light may have an intensity and/or a color temperature different from the second light. The second light emitting portion and the third light emitting portion may be arranged adjacent to each other. The third light may have a CCT being same as or different from the CCT of the second light. Preferably, the CCT of the third light is different from the CCT of the second light by at least 1000K, preferably at least 2000K, such that a sun-lit portion and a shadow portion are created on the rim. Such an embodiment offers the advantage of enhanced emulation. The third light emitting surface may be attached to a portion of the rim and a portion of the first light emitting surface. The surface area of the first light emitting surface may be greater than the surface area of the third light emitting surface. In particular, the third light emitting surface may be arranged at the portion of the rim being opposite to the second light emitting surface. In such an embodiment, the third light emitting surface will resemble the dark or shadowed portion of the rim.

According to another embodiment of the present invention, an artificial skylight of the present invention comprises a first light emitting surface arranged to emit a first light (for) resembling the sky. The first light emitting surface has been described in greater detail above. The artificial skylight further comprises a light exit window panel arranged downstream from the first light emitting surface, wherein the light exit window panel is configured to allow at least a portion of the first light to exit the artificial skylight.

Preferably, the portion of the first light exiting the artificial skylight is the major portion of the first light. More preferably, all the first light exits the artificial skylight. The term “downstream” is in the context of the present invention understood as being arranged at a distance in the direction of propagation of the electromagnetic energy. The light exit window panel should be transparent or translucent in order to allow the artificial skylight to pass.

Further, the light exit window panel should be clear and non-diffusive. The shape and size of the light exit window panel may correspond to the shape and size of the first light emitting surface. In particular, the light exit window panel may be rectangular, square, circular, or triangular. Preferably, the light exit window panel and/or the first light emitting surface is not rectangular and/or have a surface area larger than the area delimited by the periphery of the rim. The area delimited by the periphery of the rim may be fully covered by the light exit window panel and/or the first light emitting surface.

The surface area of the light exit window panel and/or the first light emitting surface may be at least 5% larger than the area delimited by the periphery of the rim. More preferably, the surface area may be at least 5% larger and at most 40% larger than the area delimited by the periphery of the rim.

The area of the first light emitting panel may be the same as the area of the light exit window panel. Alternatively, the area of the first light emitting panel may be greater than the area of the light exit window panel. Such an embodiment is particularly useful when the light exit window panel is tilted, as will be described in greater detail below.

The artificial skylight further comprises a rim circumscribing and connecting the first light emitting surface and the light exit window panel. The rim may extend (substantially) perpendicularly to the first light emitting surface. In analogy with the first embodiment, the rim comprises a second light emitting surface configured to emit a second light (for) resembling the sun light. The light exit window panel is arranged at an angle θ relative the second light emitting surface, wherein the angle θ is from 92° to 100° and/or from 80° to 88°. Typically, said light exit window panel is arranged such that a gap G is provided between a portion of said rim and said light exit window panel.

In other words, in order to create an impression of an open window, the artificial skylight according to the present invention comprises a slightly tilted or angled light exit window panel, such as a glass or polycarbonate panel, for example.

According to yet another embodiment of the present invention, an artificial skylight for providing artificial skylight light is provided, wherein the artificial skylight comprises a first light emitting surface arranged to emit a first light for resembling the sky, a light exit window panel arranged downstream from the first light emitting surface, wherein the light exit window panel is configured to allow at least a portion of the first light to exit the artificial skylight. Preferably, the portion of the first light exiting the artificial skylight is the major portion of the first light. More preferably, all the first light exits the artificial skylight. The artificial skylight further comprises a rim circumscribing and connecting the first light emitting surface and the light exit window panel, said rim further circumscribes a light exit window and extending (substantially) perpendicularly to said light exit window, wherein at least a first portion of the rim comprises a second light emitting surface configured to emit a second light for resembling the sun light. The first light emitting surface is arranged at a first angle al relative the light exit window, wherein the first angle al is in a range from 2° to 10°. Further, the light exit window panel is arranged at a second angle α2 relative the light exit window, wherein the second angle α2 is in a range from 2° to 10°. In other words, the first light emitting surface and the light exit window may be tilted in relation to the rim at different angles. The tilting of the first light emitting surface and exit window panel much be in the same direction or in different directions, so that the first light emitting surface and exit window panel are arranged at a mutual angle β1 , wherein β is in the range from 0° to 16°. In such an embodiment, the edge portion of the first light emitting surface should be invisible, which leads to a decreased effective area of the first light emitting surface.

Put differently, the artificial skylight according to the above-mentioned embodiment comprises a first light emitting surface and a light exit window panel that are slightly tilted relative to the rim. Such an embodiment offers the advantage of providing enhanced emulation. Preferably, the first angle al is equal to the second angle α2. In such an embodiment, the visible area of the first light emitting surface is maximized for a given size of the first light emitting surface.

In a short, summarized version, the invention may alternatively be expressed as: an artificial skylight for providing artificial skylight light, said artificial skylight comprising: a first surface and optionally a light exit window panel, wherein at least one of the first surface and the light exit window panel is arranged to emit through a light exit window first light for resembling the sky, said light exit window extending in a plane P; a rim extending in a perpendicular direction from the light exit window and circumscribing said first surface, wherein at least a portion of said rim comprises a second light emitting surface is configured to emit through said light exit window a second light for resembling the sunlight; wherein at least one of said first surface and said light exit window panel is pivoted by an angle θ over an axis A extending (preferably through the rim and) along plane P, wherein said angle θ is in a range from 92° to 100° and/or from 80° to 88°. The light exit window panel may be pivoted along one of its centers of rotation relative to the rim. Alternatively, the light exit window panel may be arranged such that a gap G is provided between a portion of the rim and the light exit window panel. Such embodiments provide the advantage of improved appearance of the artificial skylight. In such embodiments, at least a portion of the second light emitting surface should be arranged downstream from the light exit window panel.

The first light emitting surface may comprise a gradual increase in color temperature.

According to the present invention, the rim may be substantially rectangular and may comprise a first corner and a second corner being connected by a first face, wherein the first and the second corners may have a first height Hl in a direction (substantially) perpendicular to the first light emitting surface. The rim may further comprise a third corner (000) and a fourth corner being connected by a second face being parallel to the first face, wherein the third and the fourth corners may have a second height H2. The second height H2 may be greater than the first height, i.e. H2>H1. The first corner and the fourth corner may be connected by a third face, wherein the second corner and the third corner may be connected by a fourth face. In such an embodiment, the third face and the fourth face are perpendicular to the first and the second faces and are parallel to each other. In other words, the rim may be slanted from face to face. At least a portion of the fourth and the second faces may comprise the second light emitting surface.

According to another embodiment, the rim may be substantially rectangular and may comprise a first corner having a first height H1 in a direction (substantially) perpendicular to the first light emitting surface. The rim further comprises a second corner and a third corner being diagonally opposite to the second corner, the second corner and the third corner having a second height H2 being greater than the first height H1, i.e. H2>H1. The first corner and the second corner are connected by a first face, while the first corner and the third corner are connected by a second face, the first face being (substantially) perpendicular to the second face. The rim further comprising a fourth corner having a third height H3 being greater than the first height H1 and the second height H2, i.e. H3>H2>H1. The fourth corner is connected to the second corner by a third face being substantially parallel to the second face. The fourth corner is connected to the third corner by a fourth face being (substantially) perpendicular to the third face and substantially parallel to the first face. In other words, the rim is slanted along one of the diagonals. In analogy with the above, at least a portion of the fourth and the second faces may comprise the second light emitting surface.

According to yet another embodiment, the rim may be substantially rectangular and may comprise a first corner (000) having a first height H1 in a direction (substantially) perpendicular to the first light emitting surface. The rim further comprises a second corner having a second height H2 being greater than the first height H1, i.e. H2>H1, wherein the first and the second corner are connected by a first face. The rim further comprises a third corner being diagonally opposite to the second corner, the third corner having a third height H3 being greater than the first height H1 and the second height H2, i.e. H3>H2>H1, wherein the first corner and the third corner are connected by a second face, and wherein the first face is (substantially) perpendicular to the second face. The rim further comprises a fourth corner having a fourth height H4 being greater than the first height H1, the second height H2 and the third height H3, i.e. H4>H3>H2>H1. The fourth corner is connected to the second corner by a third face being substantially parallel to the second face, the fourth corner is also connected to the third corner by a fourth face being (substantially) perpendicular to the third face and substantially parallel to the first face. In other words, the rim is slanted in an irregular manner. At least a portion of the fourth and the second faces may comprise the second light emitting surface. Such an embodiment provides the artificial sky light offering a superior user experience.

At least a first face portion of the first face may comprise the second light emitting surface, at least a second face portion of the second face may comprise the second light emitting surface and/or at least a third face portion of the third face may comprise the second light emitting surface. Preferably, the fourth face is free from the second light emitting surface.

It should be noted that the second light emitting surface for resembling the sun may be arranged on at least a portion of at least one face of the rim. In particular, the second light emitting surface may be arranged on two faces of the rim or three faces of the rim or four faces of the rim.

The rim may comprise a second light emitting surface emitting the second light having a first rim intensity. Further, the rim may comprise a second light emitting surface emitting the second light having a second rim intensity. The first rim intensity may be different from the second rim intensity. In particular, the first rim intensity may be greater than the second rim intensity. The above-mentioned portion of the rim may be arranged adjacent to each other, such that the user perceives the rim to comprise sun-lit and shaded portions.

The artificial skylight according to the present invention may further comprise a control unit, coupled to and configured to independently control the first light emitting surface and the second light emitting surface and third light emitting surface.

Hence, the degree of control of the light emitted by the artificial skylight may be increased. An increase of degree of control of the light emitted by the artificial skylight may increase the degree of similarity of the artificial skylight to that of a natural window or skylight. The control unit may be configured to control the direction of the light emitted by the artificial skylight. The direction of the light emitted by the artificial skylight may be controlled by the control unit by selectively switching on or switching off the plurality of light emitting elements. Each plurality of light emitting elements may emit light with a direction. The control unit may be further configured to control the direction of the light emitted by the artificial skylight, such that the direction of the light emitted by the artificial skylight is substantially the same direction as the direction of the sun with regards to the optical module. The control unit may be configured to selectively switch on or switch off the at least one of the plurality of the light emitting elements.

The artificial skylight may be attached to a wall or a ceiling using a mounting element. In particular, a plurality of artificial skylights according to the present invention may be arranged in a room lacking windows, but not restricted to such spaces.

In particular, the artificial skylight may for example be arranged in a corner which separates a wall and a ceiling, thereby being arranged in both a wall and a ceiling. Further, the artificial skylight may comprise a longitudinal extension and a transversal extension, which is perpendicular to the longitudinal extension. The longitudinal extension of the artificial skylight may be larger than the transversal extension. For example, the longitudinal extension of the artificial skylight may be more than 10 times larger than the transversal extension of the artificial skylight. In other words, the artificial skylight or (horizontal or vertical) window may be long and thin. The artificial skylight may be arranged in a wall or in a ceiling of a room. It may run in part across the ceiling and in part across the wall. It may also run from a first wall to a second wall. In other words, the artificial skylight may be arranged along the whole wall or the ceiling. Thereby, the appearance of the artificial skylight may become even more similar to a skylight. A person viewing the artificial skylight from a distance may not notice that the light emitted by the artificial skylight is not collimated in a direction along the longitudinal extension of the artificial skylight.

### BRIEF DESCRIPTION OF THE DRAWINGS

Exemplifying embodiments of the invention will be described below with reference to the accompanying drawings.

FIGS. 1a-1c depict an artificial skylight according to different embodiments of the present invention;

FIGS. 2-4 illustrate different configurations of the rim of the artificial skylight;

FIGS. 5-7 show different embodiments of an inclined light exit window panel;

FIG. 8a shows a perspective view of the artificial skylight;

FIG. 8b illustrates a cross-sectional view of the artificial skylight shown in FIG. 8a.

All the figures are schematic, not necessarily to scale, and generally only show parts which are necessary in order to elucidate embodiments of the present invention, wherein other parts may be omitted or merely suggested.

### DETAILED DESCRIPTION

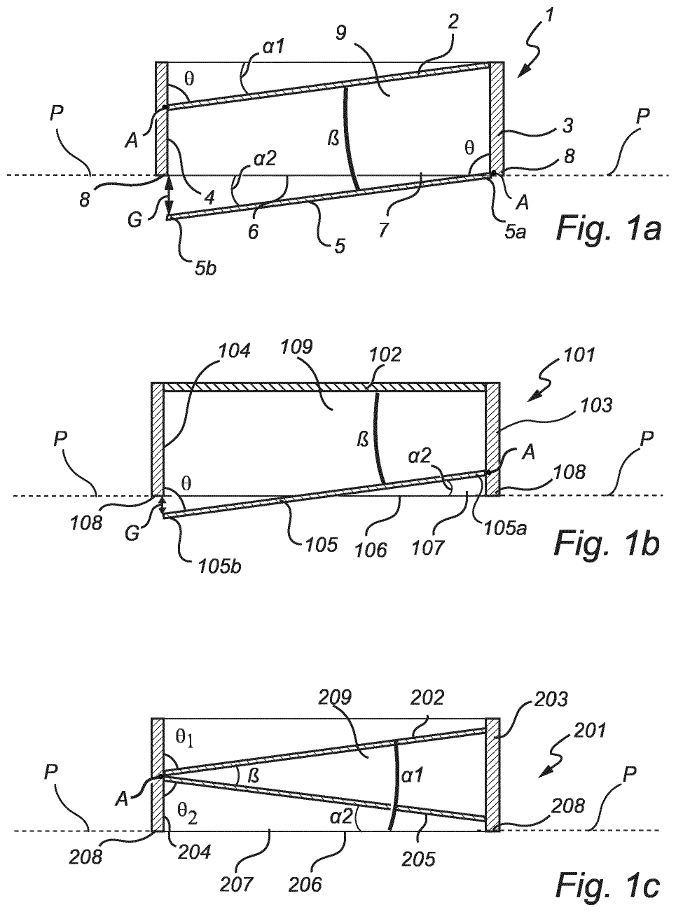

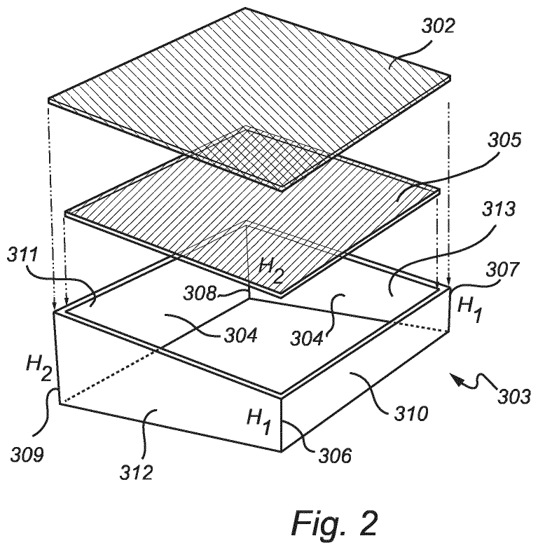

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise. Not all features as shown in FIGS. 1a-c are indicated by reference numerals in FIGS. 2 to 8b, though these features may be/are present in FIGS. 2 to 8b. In general the drawings show an artificial skylight 1 typically comprising a first light emitting surface 2 and a light exit window panel 5 arranged downstream from said first light emitting surface 2. The first light emitting surface 2 is arranged to emit through a light exit window 6 first light, wherein said light exit window 6 extends in a plane P. The artificial skylight further comprises a rim 3 extending in a perpendicular direction from the light exit window 6 and circumscribing and connecting said first light emitting surface 2 and light exit window panel 5. At least a portion of said rim 3 comprises a second light emitting surface 4 which is configured to emit through said light exit window 6 a second light. At least said light exit window panel 5 is pivoted relative to the rim over an axis A extending through the rim 3 along plane P such that said light exit window panel 5 is arranged at an angle θ with said second light emitting surface 4, wherein θ is in a range from 92° to 100° and/or from 80° to 88°.

FIG. 1a illustrates a cross-sectional view of the artificial skylight 1 for providing artificial skylight light. The artificial skylight 1 comprises a first light emitting surface 2 arranged to emit first light (for) resembling the sky. The artificial skylight 1 further comprises a rim 3 circumscribing and connecting the first light emitting surface 2 and a light exit window panel 5 which is arranged at a light exit window 6 which extends in a plane P. Said rim 3 and said first light emitting surface define a cavity 9, which cavity 9 has the light exit window 6 as an open end 7 at a circumferential edge 8 of the rim 3, wherein at least a first portion of the rim 3 comprises a second light emitting surface 4 configured to emit a second light (for) resembling the sun light. The first light emitting surface 2 is arranged at an angle θ relative the second light emitting surface 4, wherein the angle θ is from 92° to 100° and/or from 80° to 88°, preferably in a range from 93° to 99° and/or from 81° to 87°, more preferably in a range from 94° to 98° and/or from 82° to 86°, most preferably in a range from 95° to 97° and/or from 83° to 85°. In other words, the angle between the first and the second light emitting surfaces 2, 4 is slightly deviating from 90°. The light exit window panel 5 has a first light exit window panel end 5a via which said light exit window panel 5 is attached to the circumferential edge 8 of the rim 3. Said light exit window panel 5 is arranged at an angle θ relative the second light emitting surface 4 in the range of 92° to 100° and at an angle α2 relative the light exit window 6, wherein 2°<=α2 <=10°, preferably in a range from 3°<=α2<=9°, more preferably in a range from 4°<=α2<=8°, most preferably in a range from 5°<=α2<=7°. Thereto both the light exit window panel 5 and the first light emitting surface 2 are pivoted over a respective axis A which extend along plane P through the rim 3. The first light emitting surface 2 and the light exit window 5 extend mutually parallel, i.e. at an angle β of 0°. Hence, an angle al between the first light emitting panel 2 and the light exit window 6 is equal to α2. The light exit window panel 5 has a second light exit window panel end 5b which is spaced from the circumferential edge 8 of the rim 3 by a gap G as a result of the angled orientation and point of connection the of the light exit window panel 5 with respect to the light exit window 6. Thus a relatively flat artificial skylight 1 is provided having a natural feel, resembling sunshine at an angle and/or a slightly tilted window for resembling breeze through gap G.

According to another embodiment of the present invention depicted in FIG. 1b, an artificial skylight 101 comprises a first light emitting surface 102 arranged to emit a first light (for) resembling the sky and a light exit window panel 105 arranged downstream from the first light emitting surface, wherein the light exit window panel 105 is configured to allow at least a portion of the first light to exit the artificial skylight 101. The artificial skylight 101 further comprises a rim 103 circumscribing and connecting the first light emitting surface 102 and the light exit window panel 105. Said rim 103 and said first light emitting surface 102 enclose a cavity 109, which cavity 109 has a light exit window 106 extending in a plane P. The cavity 109 has the light exit window 106 arranged opposite the first light emitting surface 102 as an open end 107 at a circumferential edge 108 of the rim 103. Said first light emitting surface 102 extends in parallel to the light exit window 106. The rim 103 comprises a second light emitting surface 104 configured to emit a second light (for) resembling the sun light. The light exit window panel 105 is arranged at an angle θ relative the second light emitting surface 104 and at an angle α2 relative to the light exit window 106, wherein the angle θ is from 92° to 100° and/or from 80° to 88° and α2 is in the range of 2°<=α2 <=10°. Said light exit window panel 105 is pivoted over an axis A which extend along plane P through the rim 103. Said light exit window panel 105 at least partly extends beyond the edge 108 of rim 103 into the cavity 109 where it is attached by a first light exit window panel end 105a to the rim 103. In other words, in order to create an impression of an open window, the artificial skylight 101 comprises a slightly tilted or angled light exit window panel 105, having a small gap G between a second end 105b of the light exit window panel 105 and the circumferential edge 108 of the rim 103.

According to yet another embodiment of the present invention illustrated in FIG. 1c, an artificial skylight 201 for providing artificial skylight light is provided, wherein the artificial skylight 201 comprises a first light emitting surface 202 arranged to emit a first light for resembling the sky, a light exit window panel 205 arranged downstream from the first light emitting surface 202, wherein the light exit window panel 205 is configured to allow at least a portion of the first light to exit the artificial skylight 201, and a rim 203 circumscribing and connecting the first light emitting surface 202 and the light exit window panel 205 and extending (substantially) perpendicularly to the first light emitting surface. Said rim 203 and said first light emitting surface 202 enclose a cavity 209, which cavity 209 has a light exit window 206 as an end 207 of the cavity 209 at the edge 208 of the rim 203, and extends in a plane P. At least a first portion of the rim 203 comprises a second light emitting surface 204 configured to emit a second light for resembling the sun light. The first light emitting surface 202 is arranged at a first acute angle θ₁ relative the second light emitting surface 204, wherein the first acute angle θ₁ is in a range from 80° to 88°. Further, the light exit window panel 205 completely arranged in the cavity 209 and is arranged at a second acute angle θ₂ relative second light emitting surface 204, wherein the second angle θ₂ is in a range from 80° to 88°. The first light emitting surface 202 is arranged at an angle α1 relative to the light exit window 206. wherein 2°<=α1<=10°, and the light exit window panel 205 is arranged at an angle α2 relative to the light exit window 205, wherein 2°<=α2 <=10°. The light exit window panel 205 and the first light emitting surface 202 are both pivoted over axis A which extends along plane P through the rim 203. The first light emitting surface 202 and the light exit window 205 are arranged at a mutual angle β, wherein 0°<β<=16°.

Put differently, the artificial skylight 201 according to the above-mentioned embodiment comprises a first light emitting surface 202 and a light exit window panel 205 that are slightly tilted relative to the rim 203 and the light exit window 206. Such an embodiment offers the advantage of providing enhanced emulation. Here, the first acute angle θ₁ is equal (in absolute value) to the second acute angle θ₂ and β=α1+α2. There is no gap between the light exit window panel 205 and the rim 203.

FIG. 2 illustrates a substantially rectangular rim comprising a first corner 306 and a second corner 307 being connected by a first face 310, wherein the first and the second corners 306, 307 have a first height H1 in a direction (substantially) perpendicular to the first light emitting surface 302. The rim further comprises a third corner 308 and a fourth corner 309 being connected by a second face 311 being parallel to the first face 310, wherein the third and the fourth corners 308, 309 have a second height H2. The second height H2 is greater than the first height, i.e. H2>H1. The first corner 306 and the fourth corner 309 are connected by a third face 312, wherein the second corner 307 and the third corner 308 are connected by a fourth face 313. In such an embodiment, the third face 312 and the fourth face 313 are perpendicular to the first and the second faces 310, 311 and are parallel to each other. In other words, the rim 303 is slanted from face to face. At least a portion of the fourth and the second faces 313, 311 may comprise the second light emitting surface 304.

According to another embodiment shown in FIG. 3, the rim is substantially rectangular and comprises a first corner 406 having a first height H1 in a direction (substantially) perpendicular to the first light emitting surface 402. The rim further comprises a second corner 407 and a third corner 408 being diagonally opposite to the second corner 407, the second corner and the third corner 407, 408 having a second height H2 being greater than the first height H1, i.e. H2>H1. The first corner 406 and the second corner 407 are connected by a first face 410, while the first corner 406 and the third corner 408 are connected by a second face 411, the first face 410 being (substantially) perpendicular to the second face 411. The rim further comprising a fourth corner 409 having a third height H3 being greater than the first height Hl and the second height H2, i.e. H3>H2>H1. The fourth corner 409 is connected to the second corner 407 by a third face 412 being substantially parallel to the second face 411. The fourth corner 409 is connected to the third corner 408 by a fourth face 413 being (substantially) perpendicular to the third face 412 and substantially parallel to the first face 410. In other words, the rim 403 is slanted along one of the diagonals. In analogy with the above, at least a portion of the fourth and the second faces 413, 411 may comprise the second light emitting surface 404.

According to yet another embodiment illustrated in FIG. 4, the rim 503 is substantially rectangular and comprises a first corner 506 having a first height H1 in a direction (substantially) perpendicular to the first light emitting surface 502. The rim 503 further comprises a second corner 507 having a second height H2 being greater than the first height H1, i.e. H2>H1, wherein the first and the second corner 506, 507 are connected by a first face 510. The rim 503 further comprises a third corner 508 being diagonally opposite to the second corner 507, the third corner 507 having a third height H3 being greater than the first height H1 and the second height H2, i.e. H3>H2>H1, wherein the first corner 506 and the third corner 508 are connected by a second face 511, and wherein the first face 510 is (substantially) perpendicular to the second face 511. The rim 503 further comprises a fourth corner 509 having a fourth height H4 being greater than the first height H1, the second height H2 and the third height H3, i.e. H4>H3>H2>H1. The fourth corner 509 is connected to the second corner 507 by a third face 512 being substantially parallel to the second face 511, the fourth corner 509 is also connected to the third corner 508 by a fourth face 513 being (substantially) perpendicular to the third face 512 and substantially parallel to the first face 510. In other words, the rim is slanted in an irregular manner. At least a portion of the fourth and the second faces 513, 511 may comprise the second light emitting surface. Such an embodiment provides the artificial sky light offering a superior user experience.

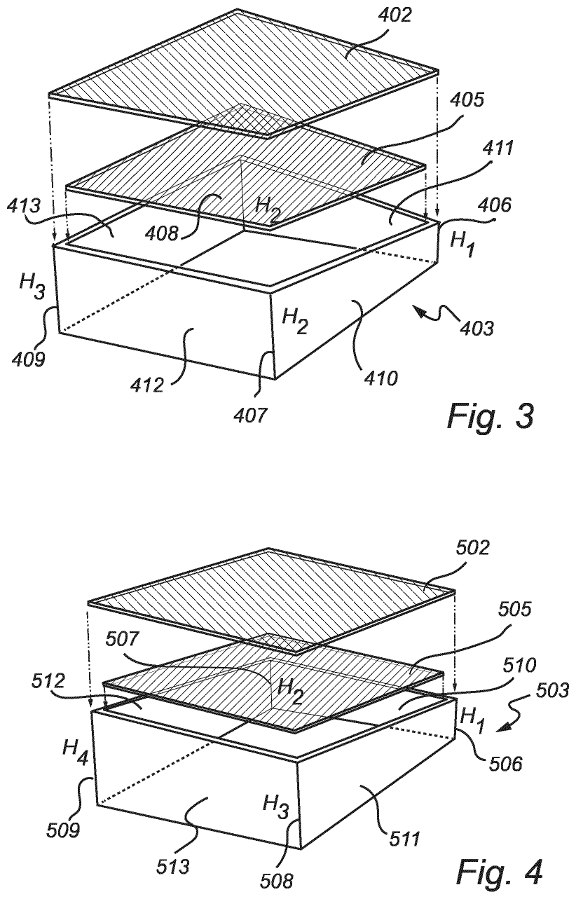

The light exit window panel 605 may be pivoted along one of its centers of rotation relative the rim 603, as shown in FIG. 5. Alternatively, the light exit window panel 605 may be arranged such that a gap G is provided between a portion of the rim 603 and the light exit window panel 605, as illustrated in FIG. 6. Such embodiments provide the advantage of improved appearance of the artificial skylight. In such embodiments, at least a portion of the second light emitting surface 604 should be arranged downstream from the light exit window panel. FIG. 7 illustrates yet another embodiment of the artificial skylight, wherein the light exit window panel comprises a first portion 605 and a second portion 605′, and wherein the second portion 605′ of the light exit window panel is tilted.

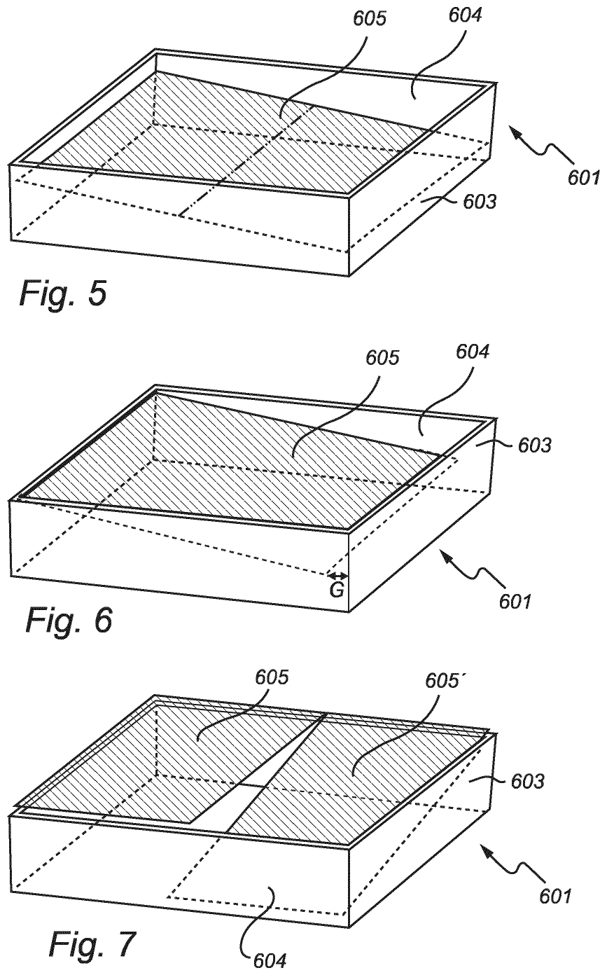

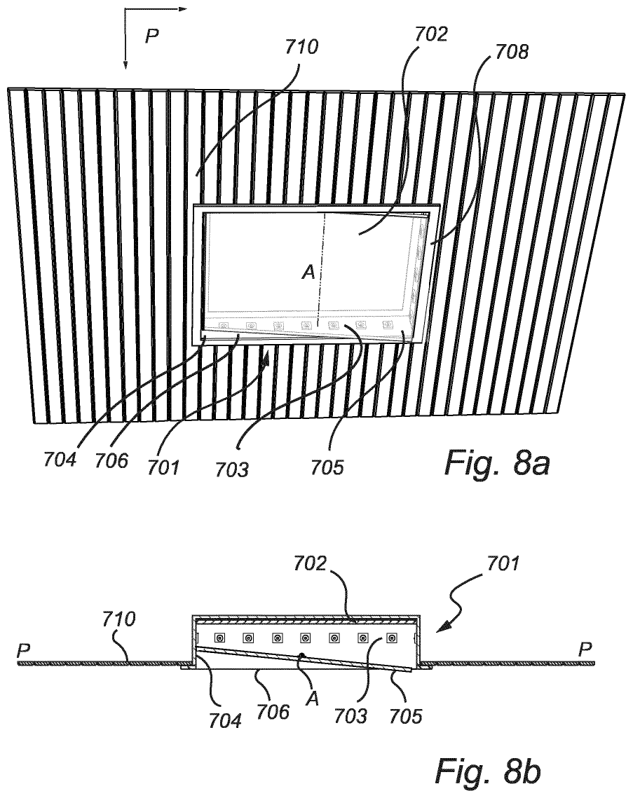

Finally, FIGS. 8a and 8b illustrate an artificial skylight 701 being arranged in a wall 710. The first light emitting surface 702 and the rim 703 are mounted in a recessed manner into the wall 710 up to the circumferential edge 708 of the rim 703, wherein the light exit window 706 lies essentially flush with the wall 710, both in plane P. The rim 703 comprises a second light emitting surface 704. As shown in FIGS. 8a and 8b, the light exit window panel 705 is tilted relative to the light exit window 706 in that it is pivoted over an axis A, which axis A extends along plane P through the rim 703. Thus, an impression of an open window is created.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An artificial skylight for providing artificial skylight light, said artificial skylight comprising:
a first light emitting surface and a light exit window panel arranged downstream from said first light emitting surface, wherein the first light emitting surface is arranged to emit through a light exit window first light for resembling the sky, said light exit window extending in a plane P;
a rim extending in a perpendicular direction from the light exit window and circumscribing and connecting said first light emitting surface and light exit window panel, wherein at least a portion of said rim comprises a second light emitting surface which is configured to emit through said light exit window a second light for resembling sunlight;
wherein at least said light exit window panel is pivoted relative to the rim over an axis A extending through the rim along plane P, such that said light exit window panel is arranged at an angle θ with said second light emitting surface, wherein θ is in a range from 92° to 100° and/or from 80° to 88°.

2. An artificial skylight as claimed in claim 1, wherein said light exit window panel is arranged such that a gap (G) is provided between a portion of said rim and said light exit window panel.

3. An artificial skylight as claimed in claim 1,
wherein said first light emitting surface is arranged at a first angle α1 relative said light exit window, wherein said first angle α1 is in a range from 2° to 10°; and
wherein said light exit window panel is arranged at a second angle α2 relative said light exit window, wherein said second angle α2 is in a range from 2° to 10°.

4. The artificial skylight according to claim 1, wherein said rim and said first light emitting surface enclose a cavity, which cavity has the light exit window as an open end at a circumferential edge of the rim, said light exit window panel at least partly extends beyond the edge into the cavity.

5. The artificial skylight according to claim 3, wherein said light exit window panel is arranged parallel to said first light emitting surface.

6. The artificial skylight according to claim 1, wherein at least a second portion of said rim comprises a third light emitting surface configured to emit a third light for resembling the shade, and wherein said third light has an intensity and/or a color temperature different from said second light, preferably wherein the second light emitting surface is greater than the third light emitting surface.

7. The artificial skylight according to claim 1 said rim being substantially rectangular and comprising a first corner and a second corner being connected by a first face, wherein said first and said second corners have a first height H1 in a direction substantially perpendicular to said first light emitting surface, said rim further comprising a third corner and a fourth corner being connected by a second face being parallel to said first face, wherein said third and said fourth corners have a second height H2, wherein H2>H1, wherein said first corner and said fourth corner are connected by a third face, wherein said second corner and said third corner are connected by a fourth face, wherein said third face and said fourth face are perpendicular to said first and said second faces and are parallel to each other and preferably wherein at least a portion of said fourth and said second faces comprises said second light emitting surface.

8. The artificial skylight according to claim 1, said rim being substantially rectangular and comprising a first corner having a first height H1 in a direction substantially perpendicular to said first light emitting surface, said rim further comprising a second corner and a third corner being diagonally opposite to said second corner, said second corner and said third corner having a second height H2 being greater than said first height H1, wherein said first corner and said second corner are connected by a first face, wherein said first corner and said third corner are connected by a second face, said first face being substantially perpendicular to said second face, said rim further comprising a fourth corner having a third height H3 being greater than said first height H1 and said second height H2, said fourth corner being connected to said second corner by a third face being substantially parallel to said second face, said fourth corner being connected to said third corner by a fourth face being substantially perpendicular to said third face and substantially parallel to said first face, and preferably wherein at least a portion of said fourth and said second faces comprises said second light emitting surface.

9. The artificial skylight according to claim 1, said rim being substantially rectangular and comprising a first corner having a first height H1 in a direction substantially perpendicular to said first light emitting surface, said rim further comprising a second corner having a second height H2 being greater than said first height H1, said first and said second corner being connected by a first face, said rim further comprising a third corner being diagonally opposite to said second corner, said third corner having a third height H3 being greater than said first height H1 and said second height H2, wherein said first corner and said third corner are connected by a second face, said first face being substantially perpendicular to said second face, said rim further comprising a fourth corner having a fourth height H4 being greater than said first height H1, and said second height H2 and said third height H3, said fourth corner being connected to said second corner by a third face being substantially parallel to said second face, said fourth corner being connected to said third corner by a fourth face being substantially perpendicular to said third face and substantially parallel to said first face, and preferably wherein at least a portion of said fourth and said second faces comprises said second light emitting surface.

10. The artificial skylight according to claim 7, wherein at least a first face portion of said first face comprises said second light emitting surface; wherein at least a second face portion of said second face comprises said second light emitting surface and/or at least a third face portion of said third face comprises said second light emitting surface, and preferably wherein said fourth face is free from said second light emitting surface.

11. The artificial skylight according to claim 1, wherein said light exit window panel and/or said first light emitting surface is flat.

12. The artificial skylight according to claim 1, wherein said light exit window panel and/or said first light emitting surface is (i) not rectangular and/or (ii) have a surface area larger than the area delimited by the periphery of the rim and wherein the area delimited by the periphery of the rim is fully covered by said light exit window panel and/or said first light emitting surface.

13. The artificial skylight according to claim 1, wherein said light exit window panel and/or said first light emitting surface is pivoted along one of its centers of rotation relative to said rim.

14. The artificial skylight according to claim 1, wherein said first light has a dominant peak wavelength in the wavelength range from 430 nm to 490 nm, and optionally wherein said second light has no dominant peak wavelength in the wavelength range from 430 nm to 490 nm.

15. The artificial skylight according to claim 1, further comprising a control unit, coupled to, and configured to independently control said first light emitting surface and said second light emitting surface and optionally said third light emitting surface.
